(19) United States
(12) Patent Application Publication
(10) Pub. No.: US 2003/0065045 A1
(43) Pub. Date: Apr. 3, 2003

(54) Preparation of rigid polyurethane foams having retarded reactivity

(76) Inventors: Peter Falke, Schwarzheide (DE); Gottfried Knorr, Schwarzheide (DE); Holger Seifert, Bohmte (DE)

Correspondence Address: BASF CORPORATION, LEGAL DEPARTMENT, 1609 BIDDLE AVENUE, WYANDOTTE, MI, 48192, US

(21) Appl. No.: 10/242,741

(22) Filed: Sep. 12, 2002

(30) Foreign Application Priority Data
Sep. 14, 2001 (DE) 10145439.2

(51) Int. Cl. C08G 18/00

(52) U.S. Cl. 521/155

(57) ABSTRACT

Rigid polyurethane foams having a retarded reactivity are prepared by reacting organic and/or modified organic polyisocyanates (a) with a polyol mixture (b) and, if required, further compounds (c) having hydrogen atoms reactive toward isocyanates, in the presence of water (d), catalysts (e), flameproofing agents (f), blowing agents (g) and, if required, further assistants and additives (h), by a process in which the polyol mixture (b) consists of

b1) at least one difunctional to octafunctional polyetherol based on ethylene oxide and, if required, propylene oxide and/or butylene oxide, the ethylene oxide content being more than 30% by weight, based on the total amount of alkylene oxide used, and having an OH number of from 200 to 1 300 mg KOH/g and

b2) at least one polyetherol based on propylene oxide and/or butylene oxide and, if required, ethylene oxide, having an OH number of from 100 to 1 000 mg KOH/g, the ethylene oxide content being not more than 30% by weight.

The resulting rigid polyurethane foams themselves having retarded reactivity are used as insulating, construction and packaging material.

The present invention relates to a process for the preparation of rigid polyurethane foams having retarded reactivity and their use as insulating, construction and packaging material.

The preparation of rigid polyurethane foams by reacting organic and/or modified organic polyisocyanates or prepolymers with compounds having higher functionality and at least two reactive hydrogen atoms, for example polyoxyalkylenepolyamines and/or preferably organic polyhydroxy compounds, in particular polyetherols and, if required, chain extenders and/or crosslinking agents, in the presence of catalysts, blowing agents, flameproofing agents, assistants and/or additives is known and has been widely described. A comprehensive overview of the preparation of the polyurethane foam is given, for example, in Kunststoff-Handbuch, Volume VII, Polyurethane, 1st Edition 1966, edited by Dr. R. Vieweg and Dr. A. Hochtlen, and 2nd Edition, 1983, and 3rd Edition, 1993, each edited by Dr. G. Oertel (Carl Hanser Verlag, Munich).

Rigid polyurethane foams are used predominantly in heat and cold insulation, for example in refrigerators and water reservoirs, in the building industry, for the insulation of pipes and as packaging material.

The blowing agents used in the past were in particular chlorofluorohydrocarbons. Owing to their destructive effect on the ozone layer, other blowing agents were proposed. These include, in addition to hydrofluoro- and fluoroalkanes, in particular hydrocarbons such as cyclopentane and pentane mixtures. Water, too, can be used as a blowing agent for a number of rigid foam applications.

Owing to the high reactivity, it is generally customary not to use rigid-foam polyols having reactive primary OH groups since the flow behavior is greatly impaired in the case of the system composition required for achieving the mechanical properties. The rigid-foam polyols used are predominantly polyetherols based on propylene oxide, since the system reactivity can be better controlled when such polyols are used. Express reference to this is made, for example, by J. M. Buist and H. Gudgeon in Advances in Polyurethane Technology, Maclaren and Sons Ltd, London, 1968, page 190. For this reason, polyetherols comprising ethylene oxide—if employed at all—are used as a rule as an internal ethylene oxide block or in a minor amount as a secondary constituent of the polyol component.

EP-A-864602 describes, for example, rigid foams having a reduced density, which were prepared using cyclopentane, further hydrocarbons and water. The polyols used are preferably polyetherols based on aromatic amines, which have an OH number of from 300 to 600 mg KOH/g.

In DE-A-19623065, as a rule polyetherols based on propylene oxide are used. Ethylene oxide-containing polyols are used in small amounts for cell opening.

WO-A-9951655 claims open-cell rigid foams. Here, prepolymers which are prepared using ethylene oxide-rich polyols are employed. In addition, lower polyethylene glycols are used in the polyol component. These measures are aimed at producing hydrophilic open-cell rigid foams.

According to EP-A-572833, open-cell rigid foams can also be prepared using propylene oxide-containing polyetherols. Here, extremely high water contents lead to open-cell foams.

In WO-A-9518163, prepolymers based on polyphenylene polyisocyanates and an ethylene oxide-containing polyol are used. These measures are intended to achieve improved adhesion to skins. The blowing agents used are in particular perfluoroalkanes in proportionate amounts.

DE-A-19723193 mentions rigid foams having reduced thermal conductivity. Some of the polyols used have an internal ethylene oxide block, which in particular is said to have an advantageous effect on the viscosity.

WO-A-9834973 claims a rigid foam which is suitable only for packaging purposes and, in addition to polyols having high ethylene oxide contents, uses in particular prepolymers having high contents of 4,4′-MDI.

EP-A-582127 describes hydrophilic rigid foams which are used as flower arranging foam. The polyols used contain ethylene oxide-containing internal blocks. As a result of the high water contents used, corresponding burning of the core can occur.

In U.S. Pat. No. 4,996,310, rigid-foam polyetherols having high ethylene oxide contents are protected. These polyols having a terminal ethylene oxide block are said to be suitable, inter alia, also for rigid foam applications. As a rule, the reactivity problems can no longer be overcome in such applications.

EP-A-463493 discloses water-blown rigid foams. These PU-PIR foams produced with relatively high indexes use small amounts of slab polyetherols having low ethylene oxide contents.

EP-A-1043350 uses an ethylene oxide-rich polyol in a proportionate amount as a comparative example. Polyether alcohols based on propylene oxide with TDA as an initiator are preferably used.

DE-A-19853025 relies on a combination of propylene oxide-containing polyetherols and amounts of an aromatic polyesteralcohol, flameproofing agents being concomitantly used.

WO-A-9734946 and EP-A-886665 describe rigid foams which also use EO-containing polyols. These formulations can be processed only with special isocyanates and furthermore only when an interfacial tension of from 6 to 14 mN/m (from 4 to 8 mN/m for the isocyanate side) is maintained, since, in the opposite case, the foam collapses. This is a serious deficiency of this system.

U.S. Pat. No. 2,902,478 describes rigid-foam polyetherols which are prepared by solid-phase synthesis. To be able to carry out this process industrially, ethylene oxide adducts are also prepared.

U.S. Pat. No. 3,153,002 discloses rigid foams which were prepared predominantly using TDI. Polyetherols based on propylene oxide and ethylene oxide are also described, the reactivity of such combinations being difficult to control.

According to the present prior art, it is difficult to obtain high-quality closed-cell rigid foams with sufficient control of the system reactivity when ethylene oxide-rich polyetherols which also have substantial amounts of primary OH groups are used.

It is an object of the present invention to use ethylene oxide-rich polyols to prepare rigid foams which, in spite of the high reactivity of the primary OH groups, exhibit retarded initiation of foaming, which advantageously affects the flow properties.

We have found that this object is achieved, surprisingly, if a polyol mixture (b) consisting of (b1) at least one difunctional to octafunctional polyetherol based on ethylene oxide and, if required, propylene oxide and/or butylene oxide, the ethylene oxide content being more than 30% by weight, based on the total amount of alkylene oxide used, and having an OH number of from 200 to 1 300 mg KOH/g and (b2) at least one polyetherol based on propylene oxide and/or butylene oxide and, if required, ethylene oxide, having an OH number of from 100 to 1 000 mg KOH/g, the ethylene oxide content being not more than 30% by weight, is used. By using the novel combination of the polyols (b), it was possible to establish the reactivity behavior of the polyurethane component, with the result that closed-cell rigid foams having good mechanical properties in combination with good process capability could be prepared.

The present invention accordingly relates to a process for the preparation of rigid polyurethane foams having retarded reactivity by reacting organic and/or modified organic polyisocyanates (a) with a polyol mixture (b) and, if required, further compounds (c) having hydrogen atoms reactive toward isocyanates, in the presence of water (d), catalysts (e), flameproofing agents (f), blowing agents (g) and, if required, further assistants and additives (h), wherein the polyol mixture (b) consists of

b1) at least one difunctional to octafunctional polyetherol based on ethylene oxide and, if required, propylene oxide and/or butylene oxide, the ethylene oxide content being not more than 30% by weight, based on the total amount of alkylene oxide used, and having an OH number of from 200 to 1 300 mg KOH/g and

b2) at least one polyetherol based on propylene oxide and/or butylene oxide and, if required, ethylene oxide, having an OH number of from 100 to 1 000 mg KOH/g, the ethylene oxide content being not more than 30% by weight.

The present invention furthermore relates to the rigid polyurethane foams themselves having retarded reactivity and prepared in this manner and to their use as insulating, construction and packaging material.

In our investigations, we have surprisingly found that, by using the novel combination of the polyols (b) with the other components, the polyurethane formation reaction is retarded and thus takes place in a controlled manner, resulting in a rigid polyurethane foam which possesses good mechanical properties and a low thermal conductivity and in particular has a long cream time.

Having retarded reactivity is understood as meaning the possibility, in formulations having high contents of reactive polyols (primary OH groups), of being able to realize good flowability and a retarded cream time while ensuring good curing.

A person skilled in the art would actually have had to expect that, owing to the high content of primary OH groups, such polyol components would not be capable of being used as rigid foam having sufficient processing properties. In particular, it could be assumed that cream time, fiber time and rise time would change in the same ratio. We have found, surprisingly, that it was possible to achieve an extension of the cream time in combination with a fixed fiber time.

Regarding the components used according to the invention in the polyol mixture, the following may be stated:

The component (b1) consists of at least one difunctional to octafunctional polyetherol based on ethylene oxide and, if required, propylene oxide and/or butylene oxide, the ethylene oxide content being more than 30, preferably more than 80, particularly preferably 100, % by weight, based on the total amount of alkylene oxide used. The polyetherols (bl) have an OH number of from 200 to 1 300, preferably from 400 to 700, mg KOH/g. The amount of primary OH groups is preferably more than 30%, particularly preferably 100%.

For example, the following are suitable as (b1) for this purpose: polyether alcohols based on trimethylolpropane, glycerol, pentaerythritol, sucrose, water, TDA, MDA, phenol Mannich condensates or sorbitol as an initiator (having a terminal ethylene oxide block or having randomly incorporated ethylene oxide). Polyetherols based on glycerol, trimethylolpropane or sorbitol with ethylene oxide are preferably used.

The component (b2) consists of at least one polyetherol based on propylene oxide and/or butylene oxide and, if required, ethylene oxide, having an OH number of from 100 to 1 000, preferably from 50 to 500, mg KOH/g, the ethylene oxide content being not more than 30% by weight.

For example, the following are suitable as (b2) for this purpose: polyetherols based on propylene glycol, dipropylene glycol, glycerol, ethylenediamine, toluenediamine, sorbitol and sucrose as an initiator. Polyetherols based on toluenediamine, ethylenediamine or sucrose and having an ethylene oxide content of less than 30% by weight are preferably used.

The amount of the component (b1) is preferably at least 50, particularly preferably more than 60, % by weight, based on the total weight of the component (b).

The amount of the component (b1) should preferably account for more than 30, particularly preferably more than 60, in particular more than 65, % by weight, based on the total of the components (b) to (h).

Said polyetherols are prepared by known processes, as described, for example, further below.

The novel rigid polyurethane foams having retarded reactivity are prepared by reacting organic and/or modified organic polyisocyanates (a) with the polyol mixture (b) described above and, if required, further compounds (c) having hydrogen atoms reactive toward isocyanates, in the presence of water (d), catalysts (e), flameproofing agents (f), blowing agents (g) and, if required, further assistants and additives (h).

According to the invention, the foams are prepared with indexes of from 70 to 150, preferably from less than 90 to 110.

Regarding the further starting components which may be used, the following may be stated specifically:

Suitable organic and/or modified organic isocyanates (a) for the preparation of the novel rigid polyurethane foams are the aliphatic, cycloaliphatic, araliphatic and preferably aromatic polyfunctional isocyanates known per se.

Specific examples are: alkylene diisocyanates having 4 to 12 carbon atoms in the alkylene radical, such as dodecane 1,12-diisocyanate, 2-ethyltetramethylene 1,4-diisocyanate, 2-methylpentamethylene 1,5-diisocyanate, tetramethylene 1,4-diisocyanate and preferably hexamethylene 1,6-diisocyanate, cycloaliphatic diisocyanates, such as cyclohexane 1,3- and 1,4-diisocyanate and any desired mixtures of these isomers, 1-isocyanato-3,3,5-trimethyl-5-isocyanatomethylcyclohexane (IPDI), hexahydrotolylene 2,4- and 2,6-diisocyanate and the corresponding isomer mixtures, dicyclohexylmethane 4,4′-, 2,2′-and 4,4′-diisocyanate and the corresponding isomer mixtures, and preferably aromatic di- and polyisocyanates, e.g. tolylene 2,4- and 2,6-diisocyanate and the corresponding isomer mixtures, diphenylmethane 4,4′-, 2,4′- and 2,2′-diisocyanate and the corresponding isomer mixtures, mixtures of diphenylmethane 4,4′- and 2,2′-diisocyanates, polyphenylpolymethylene polyisocyanates, mixtures of diphenylmethane 4,4′-, 2,4′- and 2,2′-diisocyanates and polyphenylpolymethylene polyisocyanates (crude MDI) and mixtures of crude MDI and tolylene diisocyanates. The organic di- and polyisocyanates can be used individually or in the form of their mixtures.

Frequently, modified polyfunctional isocyanates, i.e. products which are obtained by chemical reaction of organic di- and/or polyisocyanates, are also used. Examples are di- and/or polyisocyanates containing ester, urea, biuret, allophanate, carbodiimide, isocyanurate, uretdione and/or urethane groups. Specific examples are: modified diphenylmethane 4,4′-diisocyanate, modified diphenylmethane 4,4′- and 2,4′-diisocyanate mixtures, modified crude MDI or tolylene 2,4- or 2,6-diisocyanate, organic, preferably aromatic polyisocyanates containing urethane groups and having NCO contents of from 43 to 15, preferably from 31 to 21, % by weight, based on the total weight, for example reaction products with low molecular weight diols, triols, dialkylene glycols, trialkylene glycols or polyoxyalkylene glycols having molecular weights of up to 6 000, in particular up to 1 500, it being possible for these to be used as di- or polyoxyalkylene glycols individually or in the form of mixtures. Examples are: diethylene glycol, dipropylene glycol, polyoxyethylene glycols, polyoxypropylene glycols and polyoxypropylene polyoxyethylene glycols or the corresponding triols and/or tetrols. NCO-containing prepolymers having NCO contents of from 25 to 3.5, preferably from 21 to 14, % by weight, based on the total weight, prepared from the polyesterpolyols and/or preferably polyetherpolyols and diphenylmethane 4,4′-diisocyanate, mixtures of diphenylmethane 2,4′- and 4,4′-diisocyanate, tolylene 2,4- and/or 2,6-diisocyanates or crude MDI, are also suitable. Liquid polyisocyanates containing carbodiimide groups and/or isocyanurate rings and having NCO contents of from 43 to 15, preferably from 31 to 21, % by weight, based on the total weight, for example based on diphenylmethane 4,4′-, 2,4′- and/or 2,2′-diisocyanate and/or tolylene 2,4- and/or 2,6-diisocyanate, have furthermore proven useful.

The modified polyisocyanates can be mixed with one another or with unmodified organic polyisocyantes, e.g. diphenylmethane 2,4′- or 4,4′-diisocyanate, crude MDI or tolylene 2,4- and/or 2,6-diisocyanate.

NCO-containing prepolymers which are advantageously formed from the reaction of the isocyanates (a) with the polyetherols (b) and, if required, compounds of the components (c) and/or (d) and (g) have proven useful as modified organic polyisocyanates.

In addition to the polyetherol mixture (b) described above and used according to the invention, further compounds (c) having hydrogen atoms reactive toward isocyanates are, if required, added.

Compounds having at least two reactive hydrogen atoms are chiefly suitable for this purpose. Those having a functionality of from 2 to 8, preferably from 2 to 3, and an average molecular weight of from 300 to 8 000, preferably from 300 to 5 000, are expediently used. The hydroxyl number of the polyhydroxy compounds is as a rule from 20 to 160, preferably from 28 to 56.

The polyetherpolyols used in the components (b) and (c) are prepared by known processes, for example by anionic polymerization with alkali metal hydroxides, e.g. sodium hydroxide or potassium hydroxide, or alkali metal alcoholates, e.g. sodium methylate, sodium ethylate, potassium ethylate or potassium isopropylate, as catalysts and with addition of at least one initiator which contains from 2 to 8, preferably 2 or 3, bonded reactive hydrogen atoms per molecule, or by cationic polymerization with Lewis acids, such as antimony pentachloride, boron fluoride etherate, etc., or bleaching earths as catalysts or by double metal cyanide catalysis from one or more alkylene oxides having 2 to 4 carbon atoms in the alkylene radical. For special intended uses, monofunctional initiators may also be incorporated into the polyether structure.

Suitable alkylene oxides are, for example, tetrahydrofuran, 1,3-propylene oxide, 1,2- and 2,3-butylene oxide, styrene oxide and preferably ethylene oxide and 1,2-propylene oxide. The alkylene oxides can be used individually, alternatively in succession or as mixtures.

Examples of suitable initiator molecules are: water, organic dicarboxylic acids, such as succinic acid, adipic acid, phthalic acid and terephthalic acid, aliphatic and aromatic, unsubstituted and N-monoalkyl-, N,N-dialkyl- and N,N′-dialkyl-substituted diamines having 1 to 4 carbon atoms in the alkyl radical, such as unsubstituted and monoalkyl- and dialkyl-substituted ethylenediamine, diethylenetriamine, triethylenetetramine, 1,3-propylenediamine, 1,3- and 1,4-butylenediamine, 1,2-, 1,3-, 1,4-, 1,5- and 1,6-hexamethylenediamine, phenylenediamine, 2,3-, 2,4- and 2,6-toluenediamine and 4,4′-, 2,4′- and 2,2′-diaminodiphenylmethane. Other suitable initiator molecules are: alkanolamines, e.g. ethanolamine, N-methyl and N-ethylethanolamine, dialkanolamines, e.g. diethanolamine, N-methyl- and N-ethyldiethanolamine, and trialkanolamines, e.g. triethanolamine, and ammonia. Polyhydric, in particular dihydric and/or trihydric, alcohols, such as ethanediol, 1,2- and 2,3-propanediol, diethylene glycol, dipropylene glycol, 1,4-butanediol, 1,6-hexanediol, glycerol, trimethylolpropane and pentaerythritol, are preferably used. Higher molecular weight initiators, for example sorbitol, sucrose and toluenediamine, are preferably employed.

Suitable polyetherpolyols are furthermore polymer-modified polyetherpolyols, preferably graft polyetherpolyols, in particular those based on styrene and/or acrylonitrile, and polyetherpolyol dispersions.

The polyetherpolyols can be used individually or in the form of mixtures.

In addition to the polyetherpolyols described, for example, polyetherpolyamines and/or further polyols selected from the group consisting of the polyesterpolyols, polythioetherpolyols, polyesteramides, hydroxyl-containing polyacetals and hydroxyl-containing aliphatic polycarbonates or mixtures of at least two of said polyols can also be used. The hydroxyl number of the polyhydroxy compounds is as a rule from 20 to 80, preferably from 28 to 56.

Suitable polyesterpolyols can be prepared, for example, from organic dicarboxylic acids of 2 to 12 carbon atoms, preferably aliphatic dicarboxylic acids of 4 to 6 carbon atoms, polyhydric alcohols, preferably diols, of 2 to 12, preferably 2 to 6, carbon atoms, by conventional processes. Usually, the organic polycarboxylic acids and/or their derivatives and polyhydric alcohols are subjected to polycondensation, advantageously in a molar ratio of from 1:1 to 1:1.8, preferably from 1:1.05 to 1:1.2, in the absence of a catalyst or preferably in the presence of an esterification catalyst, expediently in an atmosphere comprising inert gas, e.g. nitrogen, carbon monoxide, helium, argon, etc., in the melt at from 150 to 250_C, preferably from 180 to 220_C, under atmospheric or reduced pressure, until the desired acid number is obtained, which is advantageously less than 10, preferably less than 2.

Examples of suitable hydroxyl-containing polyacetals are, for example, the compounds which can be prepared from glycols, such as diethylene glycol, triethylene glycol, 4,4′-dihydroxyethoxydiphenyldimethylmethane or hexanediol, and formaldehyde. Suitable polyacetals can also be prepared by polymerization of cyclic acetals. Suitable hydroxyl-containing polycarbonates are those of the type known per se, which can be prepared, for example, by reacting diols, such as 1,3-propanediol, 1,4-butanediol and/or 1,6-hexanediol, diethylene glycol, triethylene glycol or tetraethylene glycol, with diaryl carbonates, e.g. diphenyl carbonate, or phosgene. The polyesteramides include, for example, the predominantly linear condensates obtained from polybasic, saturated and/or unsaturated carboxylic acids or their anhydrides and polyhydric saturated and/or unsaturated amino alcohols or mixtures of polyhydric alcohols and amino alcohols and/or polyamines. Suitable polyetherpolyamines can be prepared from the above-mentioned polyetherpolyols by known processes. Examples are the cyanoalkylation of polyoxyalkylenepolyols and subsequent hydrogenation of the nitrile formed (U.S. Pat. No. 3,267,050) or the partial or complete amination of polyoxyalkylenepolyols with amines or ammonia in the presence of hydrogen and catalysts (DE-A-1215373).

The compounds of the component (c) can be used individually or in the form of mixtures. However, the addition of chain extenders, crosslinking agents or, if required, also mixtures thereof may prove advantageous for modifying the mechanical properties, for example the hardness. The chain extenders and/or crosslinking agents used are diols and/or triols having molecular weights of less than 400, preferably from 60 to 300. For example, aliphatic, cycloaliphatic and/or araliphatic diols of 2 to 14, preferably 4 to 10, carbon atoms, such as ethylene glycol, 1,3-propanediol, 1,10-decanediol, o-, m- and p-dihydroxycyclohexane, diethylene glycol, dipropylene glycol and preferably 1,4-butanediol, 1,6-hexanediol and bis(2-hydroxyethyl)hydroquinone, triols, such as 1,2,4- and 1,3,5-trihydroxycyclohexane, glycerol and trimethylolpropane, and low molecular weight hydroxyl-containing polyalkylene oxides based on ethylene oxide and/or 1,2-propylene oxide and the abovementioned diols and/or triols are suitable as initiator molecules.

If chain extenders, crosslinking agents or mixtures thereof are used for the preparation of the polyurethane foams, they are expediently used in an amount of up to 20, preferably from 1 to 8, % by weight, based on the weight of the component (b).

For the preparation of the novel rigid polyurethane foams, water (d) in an amount of from 0.5 to 5, preferably from 2 to 3.5, % by weight, based on the weight of the components (b) to (h), is advantageously used.

Catalysts (e) used are in particular compounds which greatly accelerate the reaction of the reactive hydrogen atoms, in particular of hydroxyl-containing compounds of the components (b) and (c), with the organic, unmodified or modified polyisocyanates (a). Organic metal compounds, preferably organic tin compounds, such as tin(II) salts of organic carboxylic acids, e.g. tin(II) acetate, tin(II) octanoate, tin(II) ethylhexanoate and tin(II) laurate, and the dialkyltin(IV) salts of organic carboxylic acids, e.g. dibutyltin diacetate, dibutyltin dilaurate, dibutyltin maleate and dibutyltin diacetate, are suitable. The organic metal compounds are used alone or, preferably, in combination with strongly basic amines. Examples are amidines, such as 2,3-dimethyl-3,4,5,6-tetrahydropyrimidine, tertiary amines, such as triethylamine, tributylamine, dimethylbenzylamine, dimethylcyclohexylamine, N-methyl-, N-ethyl- and N-cyclohexylmorpholine, N,N,N′,N′-tetramethylethylenediamine, N,N,N′,N′-tetramethylbutanediamine, N,N,N′,N′-tetramethyl-1,6-hexanediamine, pentamethyl-diethylenetriamine, tetramethyldiaminoethyl ether, bis(dimethylaminopropyl)urea, dimethylpiperazine, 1,2-dimethylimdiazole, 1-azabicyclo[3.3.0]octane and preferably 1,4-diazabicyclo[2.2.2]octane, and aminoalkanol compounds, such as triethanolamine, triisopropanolamine, N-methyl- and N-ethyldiethanolamine and dimethylethanolamine. Other suitable catalysts are: tris(dialkylaminoalkyl)-s-hexahydrotriazines, in particular tris(N,N-dimethylaminopropyl)-s-hexahydrotriazine, tetraalkylammonium hydroxides, such as tetramethylammonium hydroxide, alkali metal hydroxides, such as sodium hydroxide, and alkali metal alcoholates, such as sodium methylate and potassium isopropylate, and alkali metal salts of long-chain fatty acids having 10 to 20 carbon atoms and, if required, OH side groups. According to the invention, amine catalysts are preferred. From 0.001 to 5, in particular from 0.05 to 2, % by weight, based on the total weight of the components (b) to (h), of catalyst or catalyst combination are used.

Suitable flameproofing agents (f) are, for example, tricresyl phosphate, tris(2-chloroethyl) phosphate, tris(2-chloropropyl) phosphate, tetrakis(2-chloroethyl)ethylene diphosphate, dimethyl methanephosphonate, diethyl diethanolaminomethyl phosphonate and commercial halogen-containing polyol flameproofing agents. In addition to the abovementioned halogen-substituted phosphates, inorganic or organic flameproofing agents, such as red phosphorus, hydrated alumina, antimony trioxide, arsenic oxide, ammonium polyphosphate and calcium sulfate, expanded graphite or cyanuric acid derivatives, e.g. melamine, or mixtures of at least two flameproofing agents, such as ammonium polyphosphates and melamine, and, if required, cornstarch or ammonium polyphosphate, melamine and expanded graphite and/or, if required, aromatic polyesters may also be used for flameproofing the polyisocyanate polyadducts. Additions of melamine prove to be particularly effective. In general, it has proven expedient to use from 5 to 50, preferably from 5 to 25, parts by weight of said flameproofing agents per 100 parts by weight of the components (b) to (h).

Blowing agents (g) used in addition to water are also other blowing agents generally known from polyurethane chemistry. These include the chlorofluorocarbons (CFCs) and highly fluorinated and/or perfluorinated hydrocarbons, the use of which however is to be greatly restricted or entirely stopped for ecological reasons. In addition to the chlorofluorohydrocarbons (CFHCs) and fluorohydrocarbons (FHCs), in particular aliphatic and/or cycloaliphatic hydrocarbons, in particular pentane and cyclopentane, or acetals, e.g. methylal, are possible alternative blowing agents. These physical blowing agents are usually added to the polyol component of the system. However, they can also be added in the isocyanate component or as a combination of both the polyol component and the isocyanate component. They may also be used together with highly fluorinated and/or perfluorinated hydrocarbons in the form of an emulsion of the polyol component. Any emulsifiers used are usually oligomeric acrylates which contain polyoxyalkylene and fluoroalkane radicals bonded as side groups and have a fluorine content of from about 5 to 30% by weight. Such products are sufficiently well known from plastics chemistry, for example from EP-A-351614.

The use of carboxylic acids, e.g. formic acid, as blowing agents is also possible.

Advantageously, water mixed with a mixture of cyclopentane and isopentane or cyclopentane and butane is used.

The total amount of the blowing agent or of the blowing agent mixture used is from 1 to 35, preferably from 1 to 25, % by weight, based in each case on the total weight of the components (b) to (h).

In addition to the components described further above, further assistants and/or additives (h) may also be added to the reaction mixture for the preparation of the novel rigid polyurethane foams. Examples are surface-active substances, foam stabilizers, cell regulators, fillers, dyes, pigments, hydrolysis stabilizers and fungistatic and bacteriostatic substances.

Examples of suitable surface-active substances are compounds which serve for supporting the homogenization of starting materials and, if required, are also suitable for regulating the cell structure of the plastics. Examples are emulsifiers, such as the sodium salts of castor oil sulfates and of fatty acids and the salts of fatty acids with amines, for example of oleic acid with diethylamine, of stearic acid with diethanolamine and of ricinoleic acid with diethanolamine, salts of sulfonic acids, for example alkali metal or ammonium salts of dodecylbenzene- or dinaphthylmethanedisulfonic acid and ricinoleic acid, foam stabilizers, such as siloxane/oxyalkylene copolymers and other organopolysiloxanes, oxyethylated alkylphenols, oxyethylated fatty alcohols, liquid paraffins, castor oil esters or ricinoleic esters, Turkey red oil and peanut oil, and cell regulators, such as paraffins, fatty alcohols and dimethylpolysiloxanes. Frequently used stabilizers are organopolysiloxanes, which are at least partly water-soluble. These are polydimethylsiloxane radicals onto which a polyether chain comprising ethylene oxide and propylene oxide is grafted. The surface-active substances are usually used in amounts of from 0.01 to 5 parts by weight, based on 100 parts by weight of the components (b) to (h).

Fillers, in particular reinforcing fillers, are to be understood as meaning known, conventional organic and inorganic fillers, reinforcing materials, weighting materials, compositions for improving the abrasion behavior in surface coatings, coating materials, etc. Specific examples are: inorganic fillers, such as silicate minerals, for example sheet silicates, such as antigorite, serpentine, hornblendes, amphiboles, chrysotile and talc, metal oxides, such as kaolin, aluminas, titanium oxides and iron oxides, metal salts, such as chalk and barite, and inorganic pigments, such as cadmium sulfide and zinc sulfide, and glass, etc. Kaolin (china clay), aluminum silicate and coprecipitates of barium sulfate and aluminum silicate, and natural and synthetic fibrous minerals, such as wollastonite, metal fibers and in particular glass fibers of various lengths, which, if required, may be sized, are preferably used. Examples of suitable organic fillers are: carbon, rosin, cyclopentadienyl resins and graft polymers and cellulosic fibers, polyamide, polyacrylonitrile, polyurethane and polyester fibers based on aromatic and/or aliphatic dicarboxylic esters and in particular carbon fibers. The inorganic and organic fillers may be used individually or as mixtures and are incorporated into the reaction mixture advantageously in amounts of from 0.5 to 50, preferably from 1 to 40, % by weight, based on the weight of the components (a) to (h), although the content of mats, nonwovens and woven fabrics of natural and synthetic fibers may reach values up to 80.

Further information on the abovementioned other conventional assistants and additives is to be found in the technical literature, for example the monograph by J. H. Saunders and K. C. Frisch, High Polymers, Volume XVI, Polyurethanes, Parts 1 and 2, Interscience Publishers 1962 and 1964, or the above-cited Kunststoffhandbuch, Polyurethane, Volume VII, Hanser-Verlag Munich, Vienna, 1st to 3rd Edition.

For the preparation of the novel rigid polyurethane foams, the organic and/or modified organic polyisocyanates (a), polyol mixture (b) and any further compounds having at least two reactive hydrogen atoms (c) are reacted in amounts such that the ratio of the number of equivalents of NCO groups of the polyisocyanates (a) to the sum of the reactive hydrogen atoms of the components (b) and (c) is from 0.80:1 to 1.20:1, preferably from 0.90:1 to 1.10:1.

Polyurethane foams according to the novel process are advantageously prepared by the one-shot method, for example with the aid of the high pressure or low pressure technique in open or closed molds, for example metallic molds. The continuous application of the reaction mixture to suitable belt lines for producing slabstock foams is also customary.

It has proven particularly advantageous to employ the two-component process and to combine the components (b) to (h) to give a polyol component, often also referred to as component A, and to use the organic and/or modified organic polyisocyanates (a), particularly preferably an NCO prepolymer or mixtures of this prepolymer and further polyisocyanates, and, if required, blowing agents as the isocyanate component, often also referred to as component B.

The polyol component, consisting of at least parts of the components (b) to (g) and, if required, (h), forms an emulsion when hydrocarbons are concomitantly used as additional blowing agent. Without the concomitant use of emulsifiers, this emulsion is stable only with stirring. It can be resuspended as desired. The rigid polyurethane foams prepared by the novel process have a density of from 10 to 800, preferably from 20 to 100, in particular from 25 to 80, kg/m³. It has proven particularly advantageous that, in spite of the presence of the large amounts of primary OH groups, good flow behavior, good curing and good thermal conductivity are observed. A prolonged cream time, which is an advantage in terms of application technology, is noteworthy here.

They are particularly suitable as insulating, construction and packaging materials.

The examples which follow illustrate the invention without restricting it.

### EXAMPLES

Examples 6, 7 and 8 are comparative examples.

| | | Examples | | | | | | | | |
|---|---|---|---|---|---|---|---|---|---|---|
| Component | Unit | 1 | 2 | 3 | 4 | 5 | 6 | 7 | 8 | 9 |
| Polyol b1 | W/w | 72.4 | 72.4 | 72.4 | 72.4 | 72.4 | | | | 72.4 |
| Polyol b2a | W/w | | | | | | 72.4 | 72.4 | 72.4 | |
| Polyol b2b | W/w | 21.25 | 21.25 | 21.25 | 21.25 | 21.25 | 21.25 | 21.25 | 21.25 | 21.25 |
| DMCHA | W/w | 0.25 | 0.5 | 0.5 | 0.3 | 0.4 | 0.7 | 0.8 | 0.8 | 0.4 |
| N 201 | W/w | 0.2 | 0.2 | 0.2 | 0.2 | 0.2 | 0.7 | 0.7 | 0.7 | |
| N 206 | W/w | 0.15 | 0.15 | 0.15 | 0.15 | 0.15 | 0.7 | 0.7 | 0.7 | 0.4 |
| B 8468 | W/w | 2.5 | 2.5 | 2.5 | 2.5 | 2.5 | 2.5 | 2.5 | 2.5 | 2.5 |
| Water | W/w | 3 | 2 | 2 | 2 | 2 | 3 | 2 | 2 | 2.3 |
| Cyclopentane | W/w | | 13 | 3 | 13 | 13 | | 13 | 3 | 15 |
| Cream time | s | 23 | 26 | 24 | 32 | 32 | 7 | 7 | 7 | 18 |
| Fiber time | s | 42 | 50 | 41 | 65 | 59 | 41 | 51 | 41 | 51 |
| Rise time | s | 56 | 68 | 55 | 93 | 93 | 57 | 81 | 73 | 70 |
| Density | g/cm³ | 52.2 | 32.8 | 52.6 | 33.9 | 33.8 | 48.8 | 30,6 | 50.6 | 28.4 |
| Bolt test (5 min) | N | 108 | 71 | 113 | 72 | 74 | 169 | 93 | 170 | 77 |

The reaction times of the foams were set for identical fiber times.

B component: Lupranat® M20S, Polyphenylenepolymethylene polyisocyanate, NCO content 31.6% by weight (BASF); index 105;

Polyol b1—OH number 605 mg KOH/g, polyether alcohol based on ethylene oxide, trimethylolpropane initiator (BASF);

Polyol b2a—OH number 400 mg KOH/g, polyether alcohol based on propylene oxide and ethylene oxide (22% by weight), TDA initiator (BASF);

Polyol b2b—OH number 470 mg KOH/g, polyether alcohol based on propylene oxide, ethylenediamine initiator (BASF);

DMCHA—Catalyst (BASF);

N 201, N 206-Lupragen® N 201, N 206-catalysts (BASF);

B 8467—Silicone stabilizer (Goldschmidt);

Bolt test: Determination of the curing by pressing in a bolt and measuring the force.

We claim:

1. A process for the preparation of rigid polyurethane foams having retarded reactivity by reacting organic and/or modified organic polyisocyanates (a) with a polyol mixture (b) and, if required, further compounds (c) having hydrogen atoms reactive toward isocyanates, in the presence of water (d), catalysts (e), flameproofing agents (f), blowing agents (g) and, if required, further assistants and additives (h), wherein the polyol mixture (b) consists of
b1) at least one difunctional to octafunctional polyetherol based on ethylene oxide and, if required, propylene oxide and/or butylene oxide, the ethylene oxide content being more than 30% by weight, based on the total amount of alkylene oxide used, and having an OH number of from 200 to 1 300 mg KOH/g and
b2) at least one polyetherol based on propylene oxide and/or butylene oxide and, if required, ethylene oxide, having an OH number of from 100 to 1 000 mg KOH/g, the ethylene oxide content being not more than 30% by weight.

2. A process as claimed in claim 1, wherein the polyetherol (b1) has an ethylene oxide content of more than 60% by weight, based on the total amount of alkylene oxide used.

3. A process as claimed in claim 1, wherein the polyetherol (b1) contains more than 30% of primary OH groups.

4. A process as claimed in claim 1, wherein the polyetherol (b1) is used in amounts of more than 30, preferably more than 60, % by weight, based on the total weight of the components (b) to (h).

5. A process as claimed in claim 1, wherein the polyol (b1) is used in amounts of at least 50% by weight, based on the total weight of the component (b).

6. A process as claimed in claim 1, wherein mixtures of cyclopentanes and/or aliphatic hydrocarbons and/or fluorohydrocarbons are used as blowing agents.

7. A process as claimed in claim 1, wherein the polyol component, comprising at least parts of the components (b) to (h), forms an emulsion.

8. A process as claimed in claim 1, wherein the organic and/or modified organic polyisocyanates (a) used are tolylene diisocyanate, mixtures of diphenylmethane diisocyanate isomers, mixtures of diphenylmethane diisocyanate and polyphenylpolymethyl polyisocyanate or tolylene diisocyanate with diphenylmethane diisocyanate and in particular polyphenylpolymethyl polyisocyanate.

9. A process as claimed in claim 1, wherein the organic and/or modified organic polyisocyanates (a) used are NCO-containing prepolymers formed by reacting isocyanates with the polyetherols (b) and, if required, compounds of the components (c) and/or (d).

10. A rigid polyurethane foam having retarded reactivity, which can be prepared as claimed in claim 1.

11. The use of a rigid polyurethane foam as claimed in claim 10 as insulating, construction and packaging material.
